(19) United States
(12) Patent Application Publication
(10) Pub. No.: US 2010/0216626 A1
(43) Pub. Date: Aug. 26, 2010

(54) Aluminum resistant refractory composition and method

(75) Inventors: Saied Afshar, Montreal (CA); Claude Allaire, Ste-Eustache (CA)

Correspondence Address: Pearne & Gordon LLP, 1801 East 9th Street, Suite 1200, Cleveland, OH, 44114-3108, US

(73) Assignee: WAHL REFRACTORY SOLUTIONS, LLC

(21) Appl. No.: 12/448,292

(22) PCT Filed: Dec. 13, 2007
(86) PCT No.: PCT/US2007/025472

§ 371 Date: Apr. 23, 2010

Related U.S. Application Data
(60) Provisional application No. 60/876,500, filed on Dec. 21, 2006.

(51) Int. Cl. C04B 35/01; B05D 1/02; B05D 1/18; B05D 1/28

(52) U.S. Cl. 501/123; 427/427; 427/430.1; 427/429

(57) ABSTRACT

A refractory composition for use in contact with molten aluminum and molten aluminum alloys containing a refractory aggregate, a binder, and a treatment additive comprising a source of Sr. Methods comprising contacting a refractory composition with the Sr source to improve the resistance of the refractory to molten aluminum attack are also disclosed. Preferred treatment agents comprise Sr nitrate, Sr carbonate, Sr sulfate and Sr oxide.

### FIELD OF THE INVENTION

The invention pertains to methods and compositions for improving the resistance of refractory materials to corrosive attack caused by contact of the refractory with matter aluminum.

### BACKGROUND OF THE INVENTION

The corrosiveness of molten aluminum with regard to its effect on refractories is well documented. Chemical additives, termed “non-wetting additives”, have been placed in refractories for many years to improve the performance of such refractories in contact with molten aluminum. Aluminum fluoride, barium sulfate, and other compounds have been added for a number of years and their success in improving the corrosion resistance is well documented. Additional alloy development, the desire for producers to push more metal through furnaces, new burner development, the increase of recycling initiatives, and many other factors have increased melting temperatures in furnaces. This has a negative effect on the performance of the refractories for a number of reasons but specifically the “non-wetting additives” begin to breakdown at temperatures greater than 2000° F. The photographs shown in FIGS. 1, 2, and 3 chronicle the effect of firing temperature on the corrosion resistance of a bauxite based, 80% alumina castable with aluminum fluoride and barium sulfate used to improve their resistance to attack by molten aluminum.

As can be seen by review of FIGS. 1-3, a problem exists in the art in conjunction with refractory materials that come into direct contact with molten aluminum and molten aluminum alloys. The problem can be experienced, for example, in aluminum melting furnaces, remelting furnaces, ladles, troughs, etc. These are all subject to disruptive attack, penetration and adherence by various alloying elements, and by dross formed on the surface of the melt.

### SUMMARY OF THE INVENTION

It has been discovered that strontium dramatically improves the corrosion resistance after exposure to high temperatures. The photographs shown in FIGS. 4 and 5 demonstrate the improvement after firing to 1200° C. and 1400° C. respectively.

Command 80 A1 is a commercially available castable refractory concrete available from Wahl Refractories Inc., Fremont, Ohio. It is approximately 80% alumina, aluminum fluoride, citric acid, lithium chloride, cement, barium sulfate, fibers, and fume silica. Other castable refractory concretes which may benefit from the inventive treatment additives include X-cel Cast™ alumina refractories containing, for example, from about 50-80% alumina and Command™ alumina refractories containing from 50-95% alumina. All of these products are commercially available from Wahl Refractories. The strontium additive in the above-noted samples is SrO present in an amount of 2.0 wt %.

The invention will be further described in conjunction with the following detailed description and the appended drawings.

### IN THE DRAWINGS

FIG. 1 is a photograph of a prior art alumina castable refractory that was contacted with molten aluminum and pre-fired at 815° C.;

FIG. 2 is a photograph of another prior art alumina castable refractory that was contacted with molten aluminum and pre-fired at 1200° C.;

FIG. 3 is a photograph of another prior art alumina castable refractory that was contacted with molten aluminum and pre-fired at 1400° C.;

FIG. 4 is a photograph of a refractory alumina castable that was treated in accordance with one embodiment of the invention, contacted with molten aluminum and pre-fired at 1200° C.;

FIG. 5 is a photograph of a refractory treated similar to the sample shown in FIG. 4, but being pre-fired at 1400° C.;

FIG. 6 is a photograph of a comparative refractory sample, contacted with molten aluminum and fired at 1200° C. in the absence of use of an inventive anti-corrosive treatment;

FIG. 7 is a photograph of another comparative refractory sample treated under conditions similar to those used in FIG. 6;

FIG. 8 is a photograph of another comparative refractory sample treated under conditions similar to those used in FIGS. 6 and 7;

FIG. 9 is a photograph of another comparative refractory sample treated under conditions similar to those used in the FIG. 6-8 samples;

FIG. 10 is a photograph of another comparative refractory sample treated under conditions similar to those used in the FIG. 6-9 samples;

FIG. 11 is a photograph of another comparative refractory sample treated under conditions similar to those used in the FIG. 6-10 samples;

FIG. 12 is a photograph of another comparative refractory sample treated under conditions similar to those used in the FIG. 6-11 samples;

FIG. 13 is a photograph of another comparative refractory sample treated under condition similar to those used in the FIG. 6-12 samples;

FIG. 14 is a photograph of a refractory sample treated with a composition in accordance with the invention and under the conditions set forth in the table under the figure;

FIG. 15 is a photograph of another refractory sample treated with a composition in accordance with the invention and under the conditions set forth in the table under the figure;

FIG. 16 is a photograph of another refractory sample treated with a composition in accordance with the invention and under the conditions set forth in the table under the figure;

FIG. 17 is a photograph of another refractory sample treated with a composition in accordance with the invention and under the conditions set forth in the table under the figures; and

FIG. 18 is a photograph of another refractory sample treated with a composition in accordance with the invention and under the conditions set forth in the table under the figure.

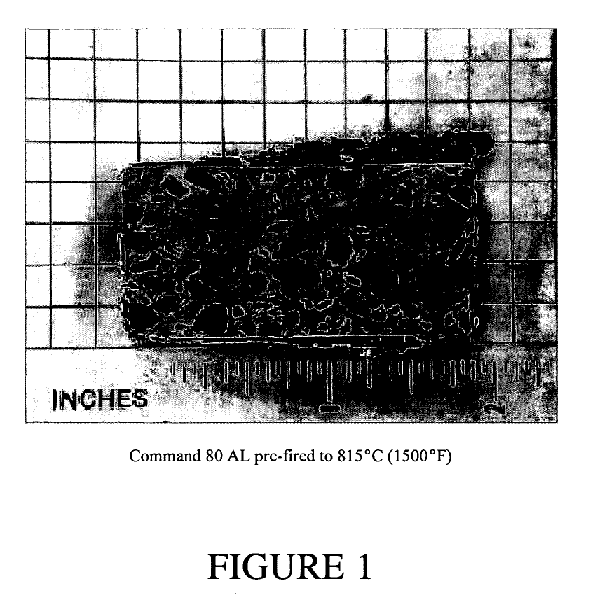

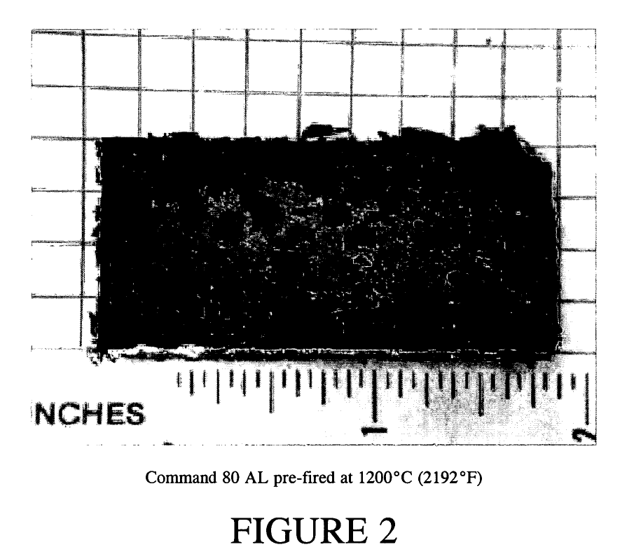

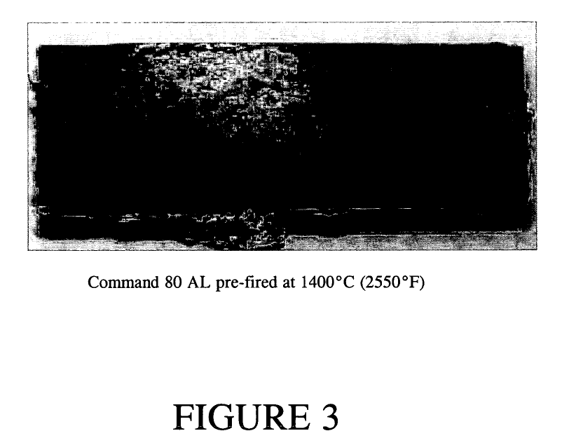

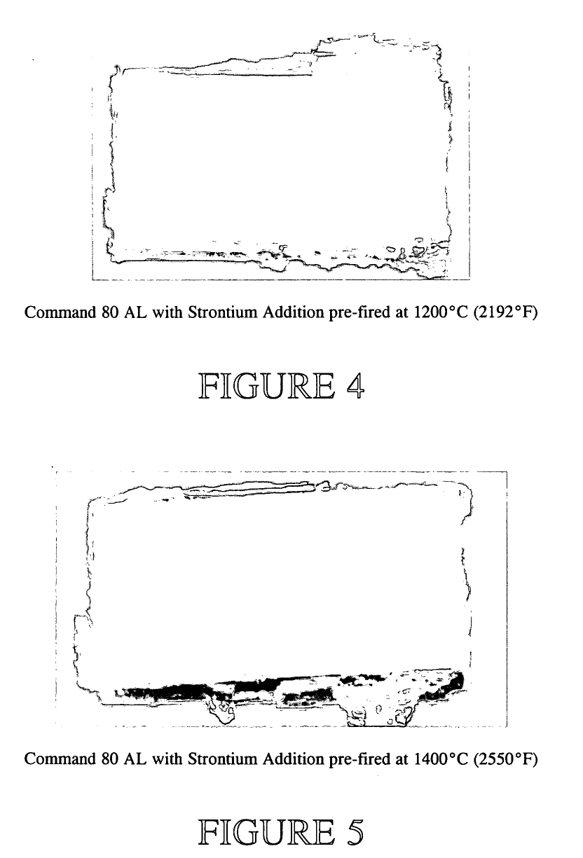

### DETAILED DESCRIPTION OF EXEMPLARY EMBODIMENTS

In accordance with the invention, there is provided a strontium based additive that is effective to impart superior resistance to Al melting and attack of a refractory material, a refractory composition containing the additive in an effective amount to impact improved aluminum resistance to the refractory composition, and a method of inhibiting corrosion of molten aluminum on refractory surfaces.

Basically, the compositions comprise refractory, binder such as a cement binder or the like, optional additives such as plasticizers, silica, retarding and accelerating agents, dispersants, surfactants, and an effective amount of strontium.

Typically, the refractory concretes are heat resistant concretes usually made with a calcium aluminate cement and a refractory aggregate. Aluminum-phosphate cement, gypsum and sodium silicate can also be used as the binder in these concretes. The binder is present in an amount sufficient to bind the refractory composition together. The refractory aggregate may be calcined mullite, kyanite, bauxite, and kaolin. Additionally, steel fibers may be incorporated in the concrete as per the disclosure of U.S. Pat. No. 4,366,255. Preferably, the refractory is a so-called high alumina refractory having from about 40 wt % and greater alumina therein.

The strontium source can comprise elemental Sr or a Sr containing compound that may include any inorganic or organic strontium compound. Preferably the Sr source is a water soluble or water miscible compound so that it may be readily added to the castable refractory concrete composition or spray or otherwise applied over existing (e.g., already cast) refractory surfaces in the form of a water solution or dispersion.

An exemplary addition range for the Sr to a castable refractory concrete composition is from about 0.01-20 wt % based on 100% wt of the dry components of the concrete. More preferably, the Sr is added in an amount of about 0.5-10 wt %, even more preferably in an amount of about 1.0-7.5 wt % and most preferably in an amount of about 1-3 wt %. Of course, elemental Sr can also be added.

Exemplary castable refractory compositions are as follows:

| | | |
|---|---|---|
| Refractory Aggregate | 40 | wt % and greater |
| Binder (such as cement) | 1 | wt % and greater |
| Other Additives | from 0-40 | wt % |
| silica, plasticizers, surfactants, fillers, | | |
| fibers, accelerators, retarders | | |
| Sr source - elemental or compound form | 0.01-20 | wt % |
| Total dry weight of refractory | 100 | wt % |
| composition | | |

Preferably a water soluble or water dispersible Sr source compound is added to the castable mixture or brought into contact with the existent refractory structure or surface. Exemplary Sr compounds include strontium acetate, strontium bromate, strontium bromide, strontium nitrite, strontium salicylate, strontium sulfide, strontium tartarate, strontium thiosulfate, strontium chlorate, strontium chloride, strontium hydroxide, strontium lactate, strontium perchlorate, strontium-potassium chlorate, strontium nitrate, strontium carbonate, strontium sulfate and strontium oxide. At present the last four strontium compounds are preferred. As shall be used in this disclosure, the phrase Sr source shall refer to elemental Sr and organic and inorganic Sr containing compounds.

A variety of commonly used refractory mixtures, including castable or moldable formulations, slurried compositions, and pre-form fired compositions, can be rendered more resistant to molten aluminum and its alloys by incorporating a small quantity of the Sr source additive of the present invention into the formulation. For example, a castable refractory composition according to the present invention can be marketed either as a bagged castable material suitable for onsite installation and curing, or in precast and cured shapes. Castable formulations can utilize refractory aggregates such that the products will be lightweight or high density as desired.

The above referred to solids formulations are typically slurried in aqueous solution, generally at a solids content ranging from about 40-90% by weight solids.

A wide range of refractory aggregates may be utilized in the present invention such as chrome, ore, bauxite, tabular alumina, silica, zirconia, spinel, magnesia-chrome, mullite and other aluminosilicates, expanded clay and expanded shale. A wide range of refractory binder systems may be used in the present invention such as aluminum sulfate, sodium silicate, calcium aluminate, phosphate acid based binders, and other commercially available binders.

In these instances in which the Sr is applied to existing refractory structures or surfaces, a solution or dispersion of same is prepared and then brought into contact with the refractory surface. The refractory can be immersed in the Sr solution or dispersion or the Sr solution or dispersion can be sprayed or brush coated onto the desired surface.

The following examples and comparative examples demonstrate the efficacy of the Sr source treatment additives. These examples are for purposes of illustration of specific embodiments of the invention, and should not be construed to limit the invention.

### Comparative Example 1

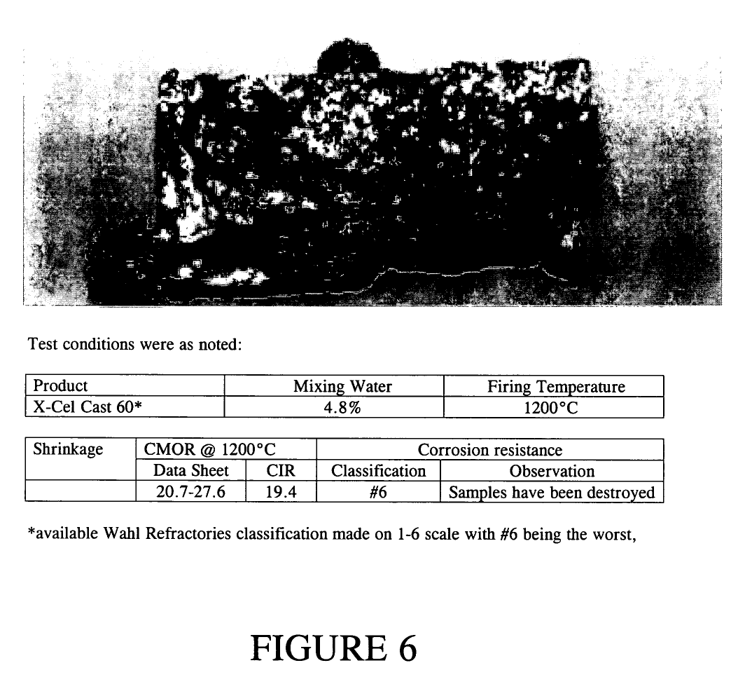

### This Sample is Shown in FIG. 6

Test conditions were as noted:

| Product | Mixing Water | Firing Temperature |
|---|---|---|
| X-Cel Cast 60* | 4.8% | 1200° C. |

| | CMOR @ 1200° C. | | Corrosion resistance | |
|---|---|---|---|---|
| Shrinkage | Data Sheet | CIR | Classification | Observation |
| | 20.7-27.6 | 19.4 | #6 | Samples have been |
| | | | | destroyed |

*available Wahl Refractories classification made on 1-6 scale with #6 being the worst,

### Comparative Example 2

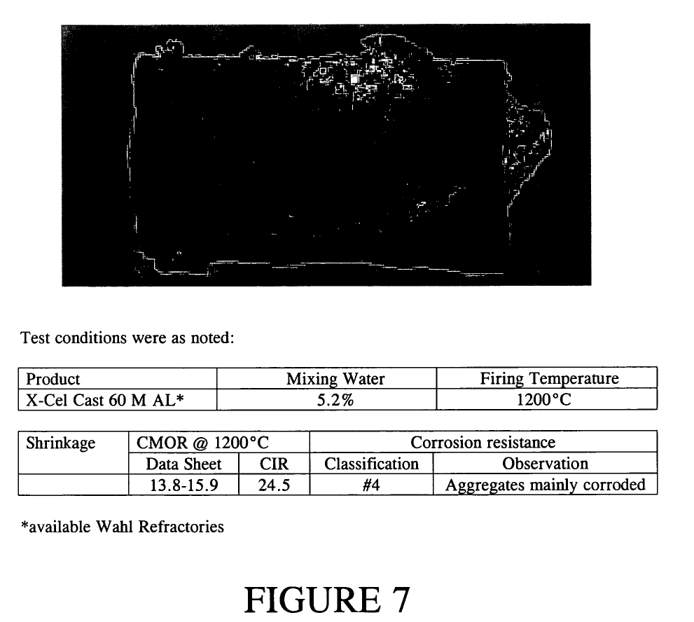

### This Sample is Shown in FIG. 7

Test conditions were as noted:

| Product | Mixing Water | Firing Temperature |
|---|---|---|
| X-Cel Cast 60 M AL* | 5.2% | 1200° C. |

| | CMOR @ 1200° C. | | Corrosion resistance | |
|---|---|---|---|---|
| Shrinkage | Data Sheet | CIR | Classification | Observation |
| | 13.8-15.9 | 24.5 | #4 | Aggregates mainly |
| | | | | corroded |

*available Wahl Refractories

### Comparative Example 3

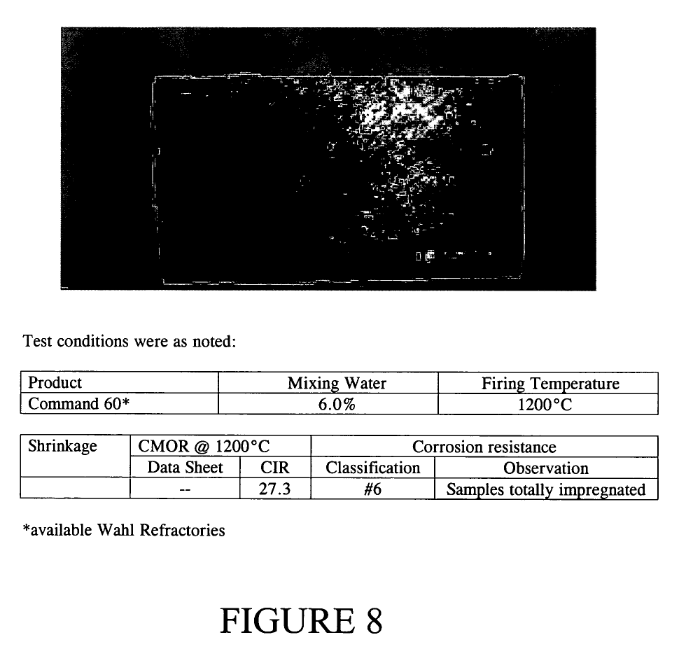

### This Sample is Shown in FIG. 8

Test conditions were as noted:

| Product | Mixing Water | Firing Temperature |
|---|---|---|
| Command 60* | 6.0% | 1200° C. |

| | CMOR @ 1200° C. | | Corrosion resistance | |
|---|---|---|---|---|
| Shrinkage | Data Sheet | CIR | Classification | Observation |
| | — | 27.3 | #6 | Samples totally |
| | | | | impregnated |

*available Wahl Refractories

### Comparative Example 4

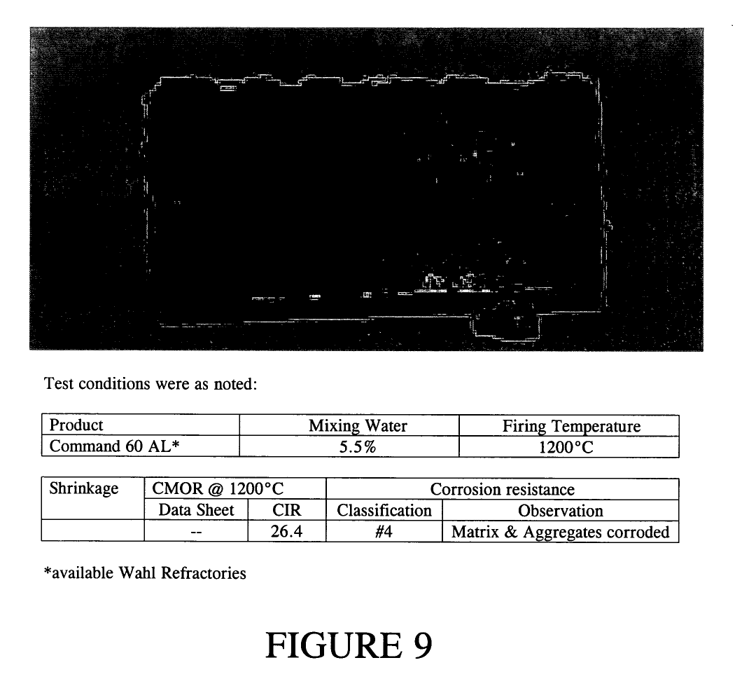

### This Sample is Shown in FIG. 9

Test conditions were as noted:

| Product | Mixing Water | Firing Temperature |
|---|---|---|
| Command 60 AL* | 5.5% | 1200° C. |

| | CMOR @ | | | |
|---|---|---|---|---|
| | 1200° C. | | Corrosion resistance | |
| Shrinkage | Data Sheet | CIR | Classification | Observation |
| | — | 26.4 | #4 | Matrix & Aggregates |
| | | | | corroded |

*available Wahl Refractories

### Comparative Example 5

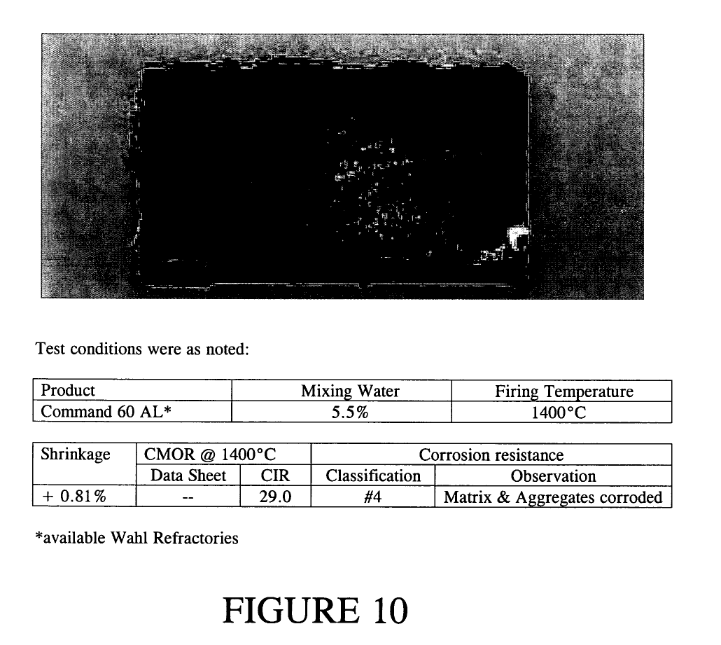

### This Sample is Shown in FIG. 10

Test conditions were as noted:

| Product | Mixing Water | Firing Temperature |
|---|---|---|
| Command 60 AL* | 5.5% | 1400° C. |

| | CMOR @ | | | |
|---|---|---|---|---|
| | 1400° C. | | Corrosion resistance | |
| Shrinkage | Data Sheet | CIR | Classification | Observation |
| +0.81% | — | 29.0 | #4 | Matrix & Aggregates |
| | | | | corroded |

*available Wahl Refractories

### Comparative Example 6

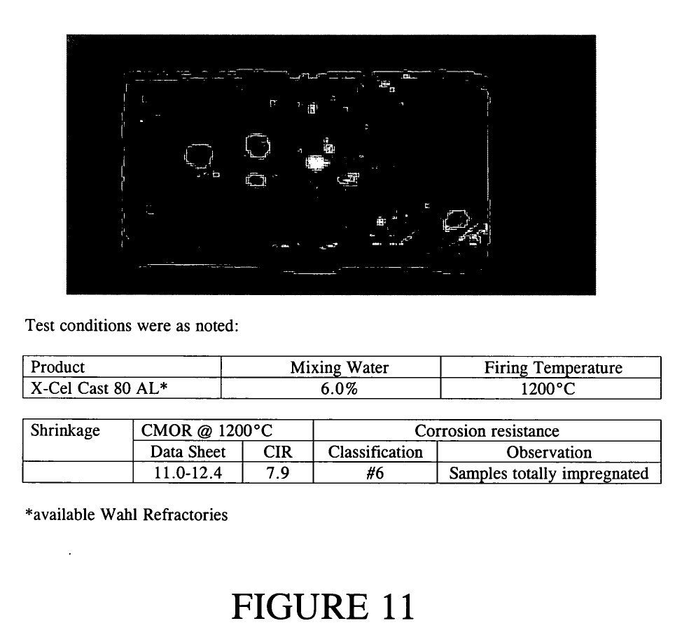

### This Sample is Shown in FIG. 11

Test conditions were as noted:

| Product | Mixing Water | Firing Temperature |
|---|---|---|
| X-Cel Cast 80 AL* | 6.0% | 1200° C. |

| | CMOR @ 1200° C. | | Corrosion resistance | |
|---|---|---|---|---|
| Shrinkage | Data Sheet | CIR | Classification | Observation |
| | 11.0-12.4 | 7.9 | #6 | Samples totally |
| | | | | impregnated |

*available Wahl Refractories

### Comparative Example 7

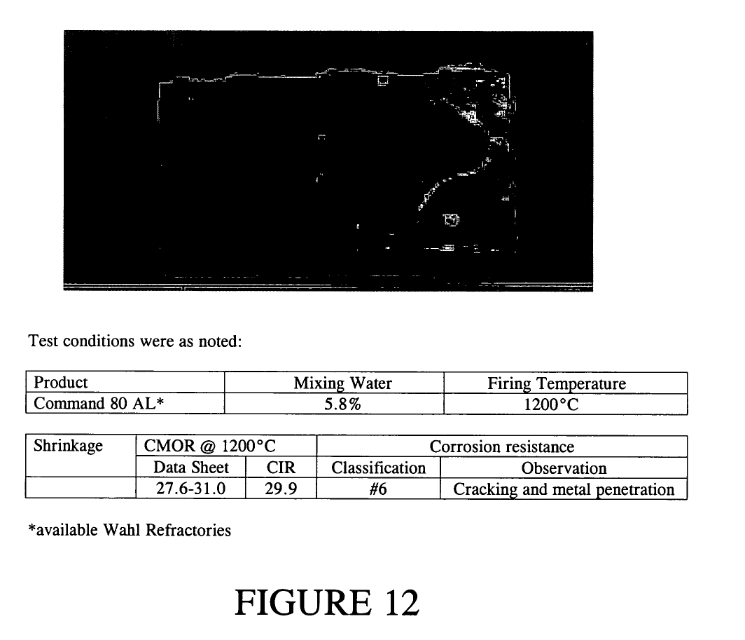

### This Sample is Shown in FIG. 12

Test conditions were as noted:

| Product | Mixing Water | Firing Temperature |
|---|---|---|
| Command 80 AL* | 5.8% | 1200° C. |

| | CMOR @ 1200° C. | | Corrosion resistance | |
|---|---|---|---|---|
| Shrinkage | Data Sheet | CIR | Classification | Observation |
| | 27.6-31.0 | 29.9 | #6 | Cracking and metal |
| | | | | penetration |

*available Wahl Refractories

### Comparative Example 8

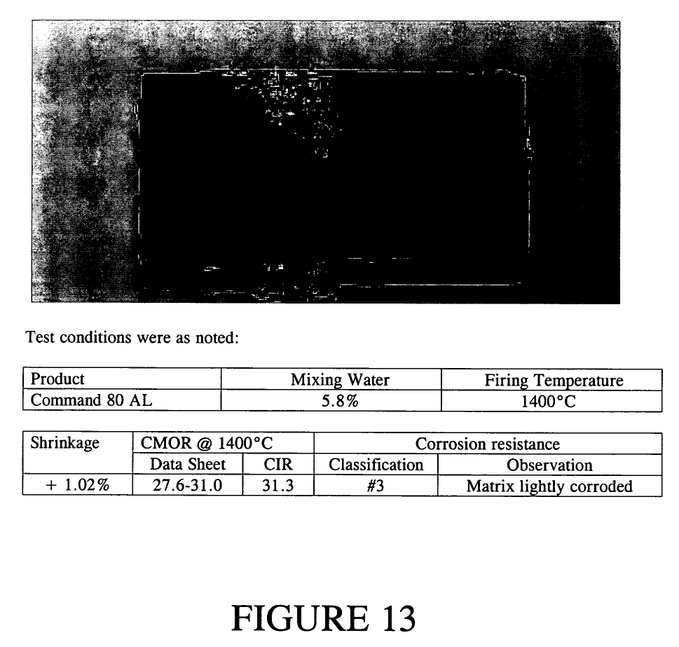

### This Sample is Shown in FIG. 13

Test conditions were as noted:

| Product | Mixing Water | Firing Temperature |
|---|---|---|
| Command 80 AL | 5.8% | 1400° C. |

| | CMOR @ | | | |
|---|---|---|---|---|
| | 1400° C. | | Corrosion resistance | |
| Shrinkage | Data Sheet | CIR | Classification | Observation |
| +1.02% | 27.6-31.0 | 31.3 | #3 | Matrix lightly corroded |

### Example 1

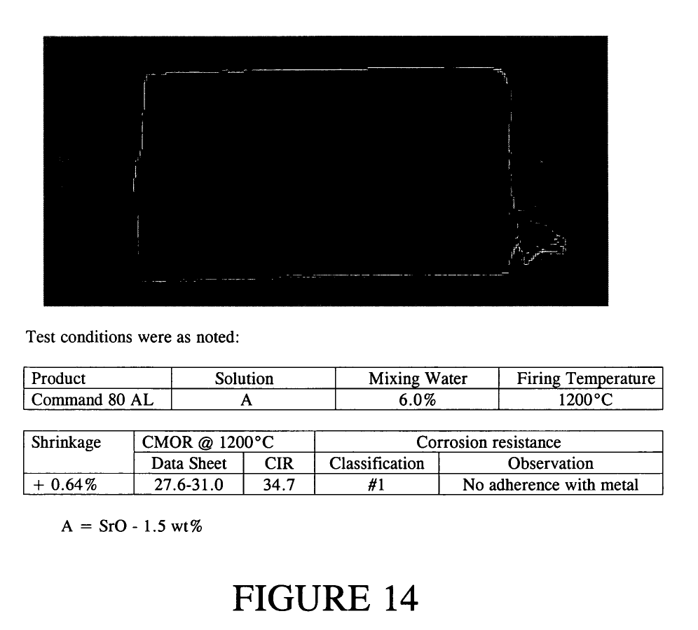

### This Sample of the Invention is Shown in FIG. 14

Test conditions were as noted:

| Product | Solution | Mixing Water | Firing Temperature |
|---|---|---|---|
| Command 80 AL | A | 6.0% | 1200° C. |

| | CMOR @ | | | |
|---|---|---|---|---|
| | 1200° C. | | Corrosion resistance | |
| Shrinkage | Data Sheet | CIR | Classification | Observation |
| +0.64% | 27.6-31.0 | 34.7 | #1 | No adherence with metal |

A = SrO —1.5 wt %

### Example 2

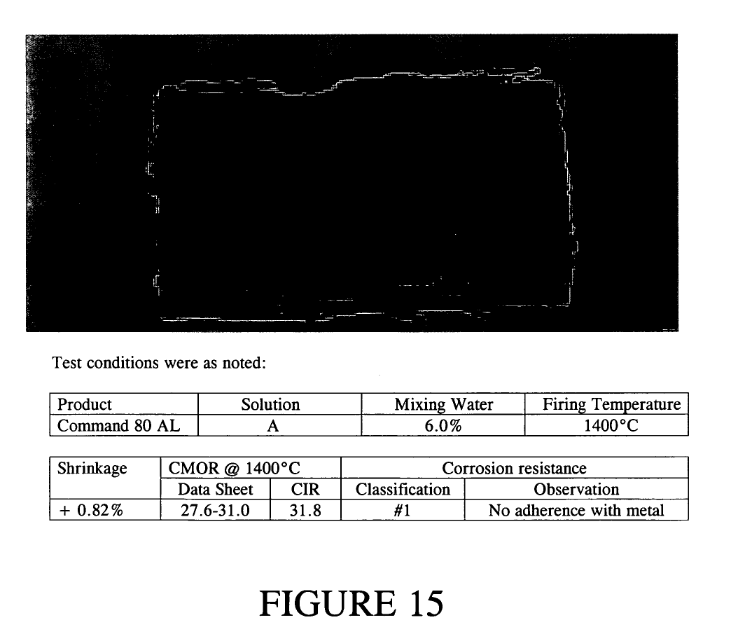

### This Sample of the Invention is Shown in FIG. 15

Test conditions were as noted:

| Product | Solution | Mixing Water | Firing Temperature |
|---|---|---|---|
| Command 80 AL | A | 6.0% | 1400° C. |

| | CMOR @ | | | |
|---|---|---|---|---|
| | 1400° C. | | Corrosion resistance | |
| Shrinkage | Data Sheet | CIR | Classification | Observation |
| +0.82% | 27.6-31.0 | 31.8 | #1 | No adherence with metal |

### Example 3

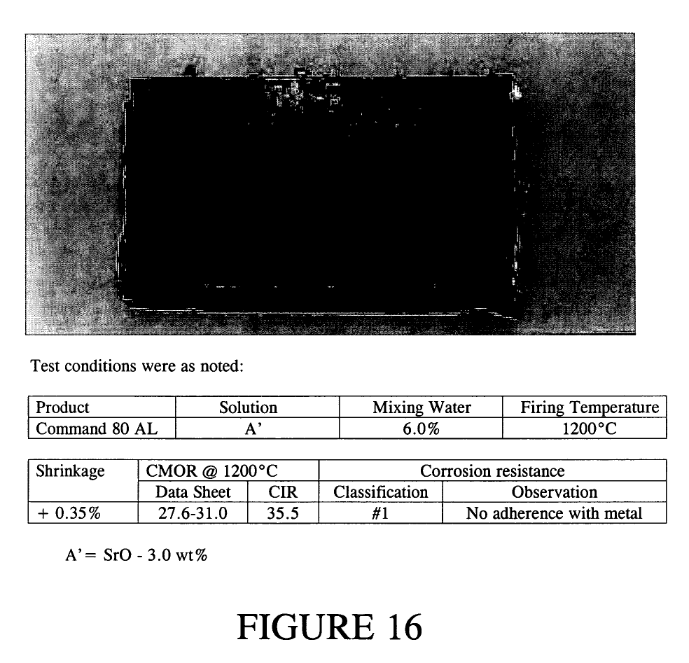

### This Sample of the Invention is Shown in FIG. 16

Test conditions were as noted:

| Product | Solution | Mixing Water | Firing Temperature |
|---|---|---|---|
| Command 80 AL | A′ | 6.0% | 1200° C. |

| | CMOR @ | | | |
|---|---|---|---|---|
| | 1200° C. | | Corrosion resistance | |
| Shrinkage | Data Sheet | CIR | Classification | Observation |
| +0.35% | 27.6-31.0 | 35.5 | #1 | No adherence with metal |

A′ = SrO —3.0 wt %

### Example 4

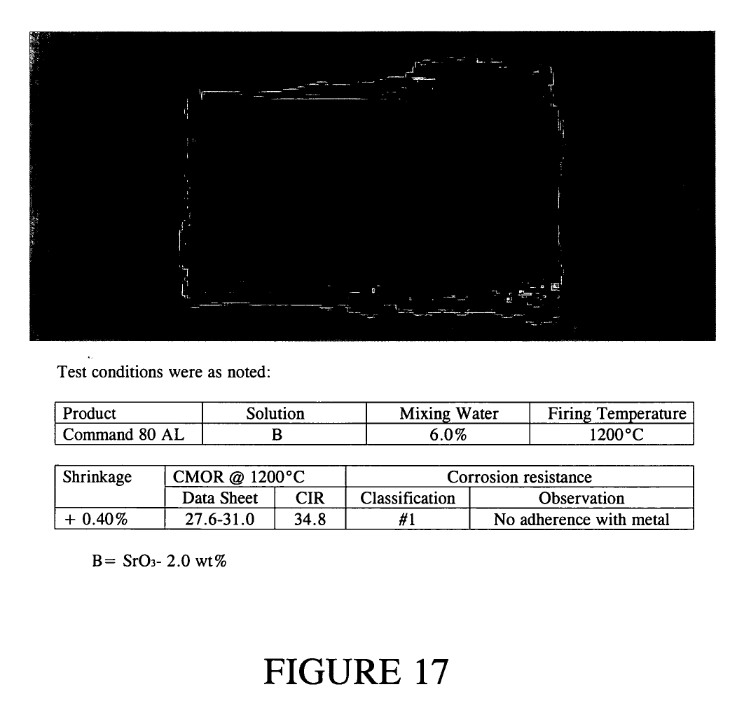

### This Sample of the Invention is Shown in FIG. 17

Test conditions were as noted:

| Product | Solution | Mixing Water | Firing Temperature |
|---|---|---|---|
| Command 80 AL | B | 6.0% | 1200° C. |

| | CMOR @ | | | |
|---|---|---|---|---|
| | 1200° C. | | Corrosion resistance | |
| Shrinkage | Data Sheet | CIR | Classification | Observation |
| +0.40% | 27.6-31.0 | 34.8 | #1 | No adherence with metal |

B = SrO₃—2.0 wt %

### Example 5

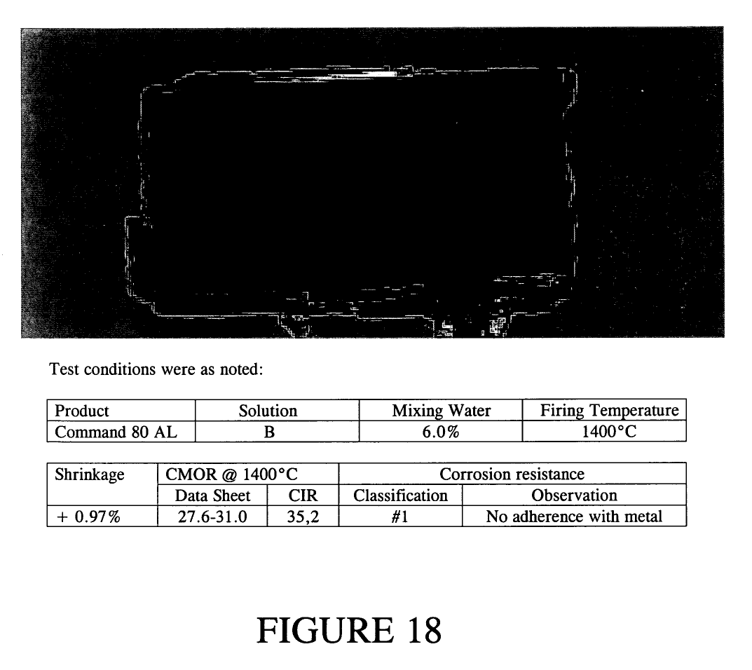

### This Sample of the Invention is Shown in FIG. 18

Test conditions were as noted:

| Product | Solution | Mixing Water | Firing Temperature |
|---|---|---|---|
| Command 80 AL | B | 6.0% | 1400° C. |

| | CMOR @ | | | |
|---|---|---|---|---|
| | 1400° C. | | Corrosion resistance | |
| Shrinkage | Data Sheet | CIR | Classification | Observation |
| +0.97% | 27.6-31.0 | 35.2 | #1 | No adherence with metal |

While this invention has been described in conjunction with the specific embodiments described above, it is evident that many alternatives, combinations, modifications and variations are apparent to those skilled in the art. Accordingly, the preferred embodiments of this invention, as set forth above are intended to be illustrative only, and not in a limiting sense. Various changes can be made without departing from the spirit and scope of this invention.

What is claimed is:

1. A refractory composition for improved resistance to attack by molten aluminum or molten aluminum alloys comprising, refractory aggregate, binder, and Sr.

2. Refractory composition as recited in claim 1 wherein said Sr comprises an Sr source including elemental Sr, organic Sr compound or inorganic Sr compound.

3. Refractory composition as recited in claim 2 wherein said Sr source is water soluble or water dispersible.

4. Refractory composition as recited in claim 3 wherein said Sr source is a member selected from the group consisting of Sr nitrate, Sr carbonate, Sr sulfate, and Sr oxide.

5. A refractory composition as recited in claim 1 wherein said refractory aggregate comprises Al aggregate present in an amount of about 40 wt % and greater based on the dry components of said composition.

6. A method of applying a treatment additive to a refractory to improve the resistance of said refractory to attack by molten aluminum comprising contacting said refractory with said treatment additive, said treatment additive comprising Sr.

7. A method as recited in claim 6 comprising contacting said refractory with a Sr source comprising a water based solution or dispersion of Sr.

8. A method as recited in claim 7 comprising spraying said solution or dispersion on said refractory.

9. A method as recited in claim 7 comprising immersing said refractory in said solution or dispersion.

10. A method as recited in claim 7 comprising brushing said solution or dispersion onto said refractory.

11. A method as recited in claim 6 wherein said Sr is chosen from SrO and SrCO₃ present in an amount of about 1-3 wt % based on the dry components of said refractory, and said treatment additive is added to said dry components of said refractory prior to formation of said refractory into a desired shape or surface.

12. A method as recited in claim 6 wherein said refractory comprises a cast refractory structure or surface, and said treatment additive is selected from the group consisting of SrO and SrCO₃, said method comprising forming a solution or dispersion of said treatment additive and then contacting said cast refractory structure or surface with said solution or said dispersion.
